(19) United States
(12) Patent Application Publication
(10) Pub. No.: US 2002/0151303 A1
(43) Pub. Date: Oct. 17, 2002

(54) Telecommunication system with a relay satellite

(76) Inventor: Frederic D'Allest, Meudon (FR)

Correspondence Address: LARSON & TAYLOR, PLC, 1199 NORTH FAIRFAX STREET, SUITE 900, ALEXANDRIA, VA, 22314, US

(21) Appl. No.: 09/833,742

(22) Filed: Apr. 13, 2001

(51) Int. Cl. H04Q 7/20

(52) U.S. Cl. 455/427; 455/428

(57) ABSTRACT

A telecommunication system enables communications between terminals distributed over a plurality of different territories constituting micro-networks. For communication between terminal and with at least one operator network, a relay satellite has communication and switching capacities for connecting at least one call and control center connected to an operator network, and a plurality of base station each allocated to a specific territory. Each base has a switching station for setting up local connections between the terminals distributed in its territory and for setting up outside connections with the call center via the satellite. The outside connections are for incoming or outcoming calls, not for calls internal to the territory.

### BACKGROUND OF THE INVENTION

The present invention relates to cellular telecommunication systems having a call and control center provided with a switching station enabling connections to be made with an operator network, generally the public switched telephone network (PSTN), and with base stations each having a transceiver for establishing connections with mobile and/or fixed terminals situated in a territory or zone served by the station.

To equip zones that do not have a terrestrial telephone infrastructure, such as developing regions or regions with low population density, an advantageous possibility is constituted by cellular telephone networks using radio links. Only a few base stations suffice to serve numerous subscribers distributed over large territories (up to 35 kilometers (km) from the base station in a global system for mobile (GSM), said distance corresponding to the duration of one frame) The investment required for connecting subscriber stations by wire is avoided.

At present, base stations in a cellular telecommunications network such as GSM comprise base stations which are connected in a star configuration to a call and control center, and each comprises a radio transceiver and a base station controller. The call and control center handles calls between subscribers without distinguishing between setting up calls between subscribers situated in the same territory or cell and setting up calls of some other nature. Under all circumstances, that architecture causes signaling and connection set-up signals, followed by voice and possibly data signals to transit between the call center and at least one base station. The links between base stations and the call center must have sufficient bandwidth to carry all of this traffic. The resources to be created represent a large amount of investment and take a long time to establish, particularly in the usual case of wired links between the base stations and the call center.

### SUMMARY OF THE INVENTION

The invention is based on several findings: a large number of calls take place within a single territory, particularly when the territory is large, as is generally the case in zones that are rural or thinly populated; satellite links make it possible to avoid installing infrastructure based on wires or microwave beams. Consequently, there is provided a telecommunications system enabling terminals that are distributed over a plurality of territories to be put into communication with one another and with at least one operator network. The system comprises at least one relay satellite provided with means for communicating firstly with at least one call and control center connected to an operator network, and secondly with a plurality of base stations each allocated to a territory and each having a switch for setting up local connections between the terminals distributed in its territory and for setting up connections with the call center via the satellite in order to set up calls other than calls internal to the territory.

By means of this disposition, calls within a given territory take place without occupying bandwidth to the call and control center, thus reserving the full bandwidth for calls to the operator network or to other territories. For “external” calls, the switch at the base station acts only to direct the call to the satellite link. By using such a relay satellite (advantageously a geostationary satellite so as to avoid problems of transferring connections from one satellite to another), the investment required for wired links are avoided.

These advantages are obtained by organizing each base station in such a manner that each territory constitutes a micro-network having switching functions that enable it to operate autonomously for internal calls and also by using a satellite link to the call and control center. Even if the micro-networks are functionally independent, they are advantageously supervised by a common network management unit situated at the call and control center.

There can be a plurality of call centers and the base stations can have means for selecting one particular center, e.g. responsive to the destination of a call.

Each base station has a subassembly having at least one transceiver and controller acting in the same manner as in a base station of a digital cellular network, and having a local switch for setting up calls, via at least one antenna, directly between remote fixed terminals and mobile terminals situated within the territory.

A major advantage of the invention is that the system can be implemented essentially by using components that already exist. The components of the terrestrial portion of a micro-network can be the same as those used in cellular radio telephone networks that already exist, such as the GSM system which makes use of time division multiple access (TDMA). The micro-networks can also make use of components of frequency division (FDMA) systems and they can be adapted to future systems such as those known as the general packet radio system (GPRS) or the universal mobile telecommunications system (UMTS).

Links with the satellite can be established using existing techniques, in particular those based on “frame relay” technology, with a star connection to the call and control center via terminals with a very small aperture terminal (VSAT) antenna. The satellite links are pre-allocated to each base station.

It is possible to use other addressing techniques, e.g. using an Internet type protocol or resource allocation by demand assignment multiple access (DAMA).

In an advantageous embodiment of the system, the resources of the satellite links are pre-allocated to each base station.

The above features and others will appear more clearly on reading the following description of a particular embodiment given by way of non-limiting example. The description refers to the accompanying drawings.

### BRIEFS DESCRIPTION OF THE DRAWINGS

FIG. 1 is a diagrammatic representation of the geographical distribution of the call and control center and a few base stations in a system;

FIG. 2 is a block diagram showing one possible architecture for the call and control center, giving more details than in FIG. 1;

FIG. 3 is similar to FIG. 2 and shows one possible architecture for a base station; and

FIG. 4 is a diagram for showing the interface between a call center and a base station via a satellite link.

### DETAILED DESCRIPTION

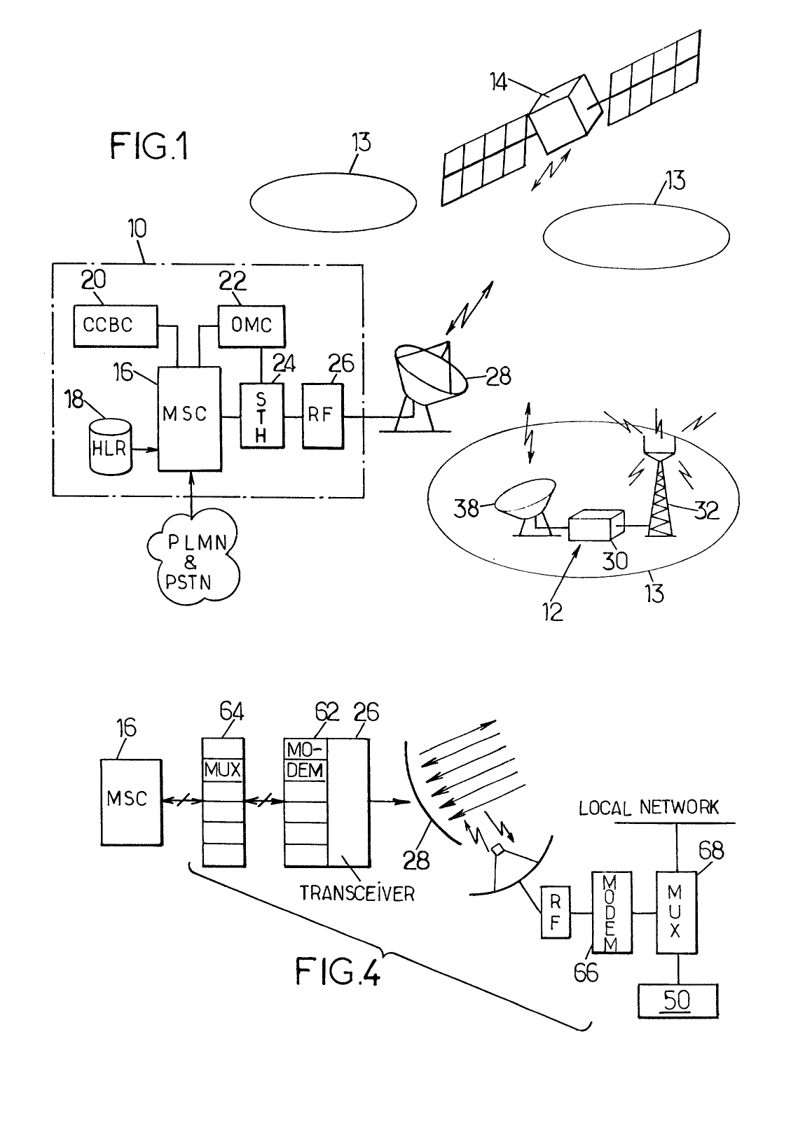

The integrated system whose overall architecture is shown in FIG. 1 provides telephone and data transmission services to mobile and/or fixed terminals between one another and with a public network by making optimum use of satellite links.

The system comprises a call and control center 10 which constitutes a network control center (NCC) and terrestrial base stations 12 located at a distance from the center 10 and serving territories which are generally disjoint. Connections between the base stations 12 and the call center 10 take place via at least one relay satellite 14 which generally has a single beam covering all of the territories 13, but which could have multiple beams providing it is itself provided with beam interconnection means. Additional base stations can be connected to the NCC by optic fibers or microwave links.

A plurality of NCCs can be provided, particularly when it is desired to allocate calls of different kinds to different NCCs, e.g. as a function of call destination (national or international).

Unlike the disposition adopted in a conventional cellular digital telephone network such as the GSM network as defined in GSM 01.02/4, the base stations have the means required for handling and routing calls within the respective territories they serve so that each territory constitutes a self-contained micro-network having its own switching capacity. Thus, it is not necessary to make use of means in the NCC 10 to handle calls between “local” terminals or terminals that are traveling through a given territory. Traffic remains local and does not load long distance links.

The essential elements of a NCC 10 are shown in FIG. 1. They comprise a mobile switch center 16 for handling calls that also provide access to a public telephone network such as the PSTN. To enable it to perform this operation, the switch 16 is connected to a home location register (HLR) 18 constituted by a database which is generally associated with a center for authenticating subscribers to the system. Elements 16 and 18, and also a customer care and billing center (CCBC) 20 and an operation and maintenance center 22 can be of a kind commonly used in existing digital cellular telephone networks.

In addition, the NCC 10 has means enabling connections to be set up via a satellite 14, which means are represented in the form of a centralizer or satellite trunking hub 24 whose structure can be as described below, a microwave transmitter 26, and an antenna 28 which is generally of large diameter suitable for establishing a link with a satellite in geostationary orbit.

The base stations 12 are also described below. At this stage it is only necessary to understand that a base station comprises a base station subassembly 30 having a local switch, a base transceiver, a modem and a controller which performs the same functions as in a conventional base station for a cellular network. Referring to FIG. 3, these elements make it possible to communicate via an antenna 32 with remote fixed terminals 34 and with mobile terminals 36, and possibly also with fixed terminals 37 that are connected to the base station by means of a local wired network. A plurality of antennas pointing towards various sites can be provided. An antenna 38, generally a parabolic antenna of smaller diameter than the antenna 28, serves to receive transmissions coming from the satellite 14 and to transmit to the satellite.

The bandwidth of the links between the satellite and each base station is determined as a function of the traffic to be passed and of the mean data rates of each of the voice, data, and signaling streams. In order to economize bandwidth as much as possible, use is generally made of a compression algorithm that provides a compression ratio that is greater than that adopted for GSM. In general, a compression algorithm is used that reduces data rate to a value that is well below 64 kilobits per second (kbits/s).

The satellite links between the base stations 12 and the NCC 10 can be permanent and of constant capacity, using a single channel per carrier (SCPC) mode. However, particularly for stations serving territories that generate little external traffic, it is advantageous to adopt DAMA in which bandwidth is continuously adapted to demand.

In systems where the traffic between two particular micro-networks is particularly large, then direct satellite links can be provided between those two micro-networks, thus reducing transmission delay by eliminating a down path. Under such circumstances, it is also possible to provide a direct terrestrial link by microwave beam, for example, between two base stations.

Structure and Terrestrial Links of a NCC

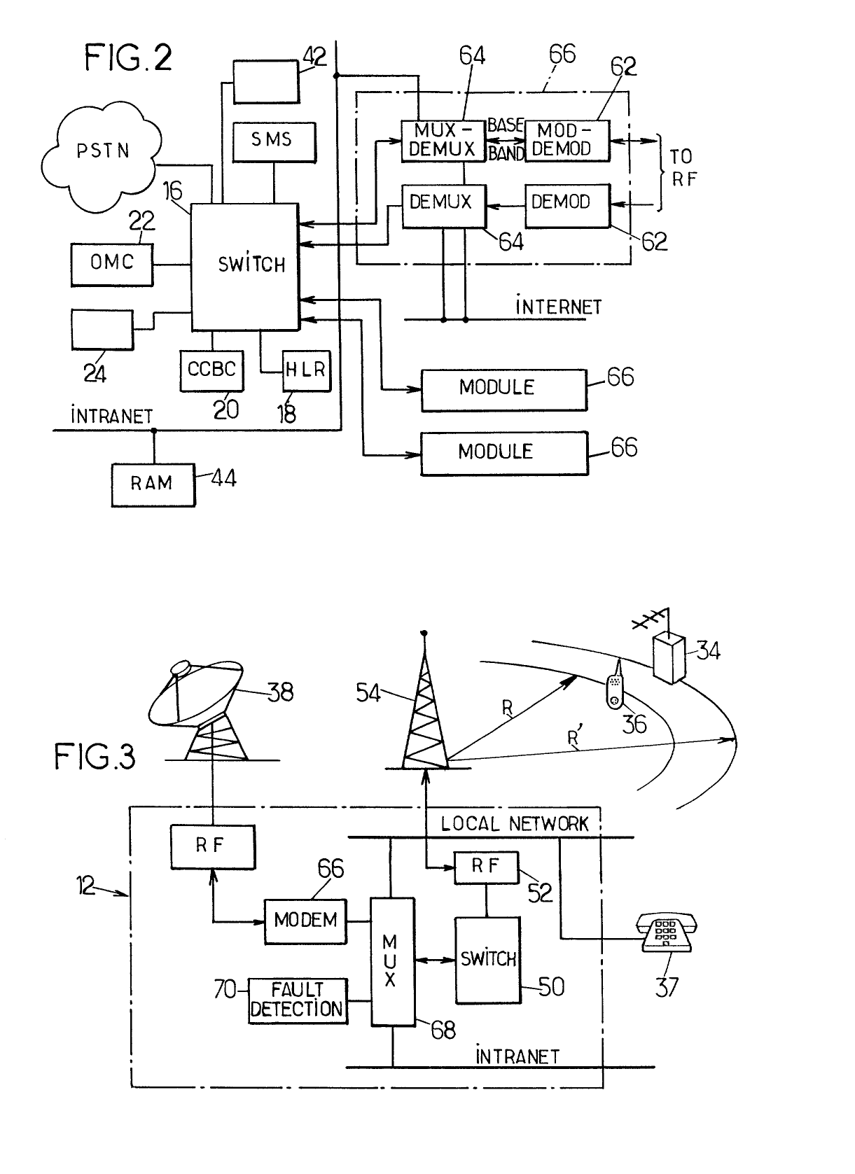

The NCC 10 whose general structure is shown in FIG. 2 includes the switch 16 for handling calls connected to the components mentioned above. The switch can also be connected to units 42 that perform additional functions such as short message service or voice message box. The centralizer or trunking hub 24 can be constituted by a plurality of modules each allocated to a group of base stations and each having a group of modulator-demodulators (modems) 62 each associated with a respective multiplexer-demultiplexer 64. One unit can be allocated solely to incoming traffic in which case it need have only a demodulator and a demultiplexer. The modules can be connected to local area networks (LANs) or to wide area networks (WANs) and also to an Internet network or to an Intranet network optionally provided with a memory 44 for storing and forwarding data.

Structure and Terrestrial Links of a Micro-network

Referring to FIG. 3, a micro-network comprises a base station 12 having a local switch 50. The switch is connected to radio means for communication with terminals distributed over the territory it serves, these means comprising at least one transceiver 52 and at least one antenna 54 of the same kind as those used in a GSM network. The terminals served by radio can comprise in particular:

conventional portable terminals 36 that can typically make a connection up to a distance R of about 7 km from the antenna in open terrain and up to about 2.5 km from within buildings; and

fixed terminals 34 that make it possible in practice to achieve a range R′ of about 30 km using a directional antenna, e.g. a Yagi antenna, and intended for home or public use.

In addition, the switch can be connected to a local terrestrial network 56 and/or to specialized data networks such as networks 58 giving Internet access, local networks (including, for example, cyber cafes or public access points), Intranet networks, etc. . . . , possibly by means of modems.

In general, the services that can be offered in a territory are of a wide variety of kinds including all those available on a GSM network, for example:

voice, generally using a compression rate that is greater than that of GSM;

voice messaging with messages being notified by displaying a short message (short message service SMS);

call transfer, display of calling number; and

a single call number for voice, fax, and data services.

Services additional to those of the GSM type can also be provided such a the services that can be conveyed by a VSAT network, e.g. point-to-point links, optionally meshed links, etc. . . . .

Satellite Links

The link via a satellite as shown in FIG. 4 uses permanent pre-allocation of carriers coming from the base stations (incoming carriers).

The antenna 28 of the NCC 10 is connected to a transceiver 26 associated with modems 62. The baseband signals transposed by the carriers are interchanged with multiplexers-demultiplexers 64 (MUX-DEMUXes) constituting the node of the system with the mobile call handling switch center 16. The MUX-DEMUXes are controlled by a satellite resource manager (not shown).

In one embodiment, which can be considered as being representative, an appropriate number of sets of satellite means is provided and each set includes:

a single broadband carrier allocated to outgoing traffic for base stations, with addressing by means of identifying headers; and

eight narrowband carriers (e.g. 256 kbits/s) each allocated to a single base station.

Each base station has a modem 66 associated with one of the MUX-DEMUXes 68. The signals pass between the MUX-DEMUX 68 and the modem 66 in packet mode or in frame relay mode. A fault detector 70 monitors operation of the modem. The MUX-DEMUX 68 can also be connected to one or more local networks. Each MUX performs statistical multiplexing and priority management. To this end, it is preceded by buffer memories of appropriate capacity to establish queues, or else it incorporates such memories.

The invention is not limited to the particular embodiments described in detail. It can be used with terrestrial networks and by satellites of kinds different from those mentioned above.

1. A telecommunication system enabling user's terminals that are distributed over a plurality of different territories constituting micro-networks to be put into communication with one another and with at least one operator network, comprising at least one relay satellite provided with means for communicating
with at least one call and control center connected to an operator network, and
with a plurality of base stations each allocated to a specific one of said territories and each having a switching station for setting up local connections between the user's terminals distributed in the specific territory thereof and for setting up outside connections with the call center via the satellite only, said outside connectors being for incoming or outcoming calls other than calls internal to the territory.

2. A system according to claim 1, wherein a terrestrial portion of the base stations are components of standard cellular radio telephone networks.

3. A system according to claim 2, wherein each base station comprises a station subassembly having a base station transceiver and at least a digital cellular network controller, a local switch arranged for directly establishing communications, through at least an antenna, between distant fixed terminals and mobile user's terminals located in the territory served by the base station.

4. A system according to claim 2, wherein each of said base stations comprises a subassembly having a base station transceiver, a digital cellular network controller and a local switch for directly establishing communications with local terrestrial networks.

5. A system according to claim 1, further comprising direct satellite links between at least two of said micro-networks and traffic interconnection capacities on-board said satellite.

6. A system according to claim 1, further having a direct terrestrial link, by wire or microwave beam between two said base stations.

7. A system according to claim 1, wherein said outside connections via the satellite are carried out on a broadband carrier dedicated to the outcoming traffic toward the base stations, with addressing by an identification header and over a plurality of carriers each having a passband narrower than that of the broadband, each dedicated to one base station for outcoming traffic from the base station.

8. A system according to claim 1, wherein the satellite links have resources which are prededicated to the base stations.

9. A system according to claim 1, having a plurality of communication center and selection means located in the base station for selecting among the communication centers from the base station.

10. In a digital telecommunication system enabling terminals that are distributed over a plurality of different territories each constituting a micro-network to be put into communication with one another and with at least one operator network, comprising at least one relay satellite provided with means for communicating
with at least one call and control center connected to an operator network, and
with a plurality of base stations each allocated to a specific territory,
a base station having (a) a switching station for setting up calls and connections between the terminals distributed in the specific territory thereof and (b) means for setting up connections with the satellite via an up-link for communications other than internal to the territory.
